(19) United States
(12) Patent Application Publication
(10) Pub. No.: US 2006/0088284 A1
(43) Pub. Date: Apr. 27, 2006

(54) Digital photo kiosk and methods for digital image processing

(76) Inventors: Paul Shen, Woodside, CA (US); Edward A. Krause, San Mateo, CA (US); Chong U. Lee, San Diego, CA (US)

Correspondence Address: Lipsitz & McAllister, LLC, 755 MAIN STREET, MONROE, CT, 06468, US

(21) Appl. No.: 10/974,262

(22) Filed: Oct. 26, 2004

(51) Int. Cl. H04N 5/93

(52) U.S. Cl. 386/52

(57) ABSTRACT

The present invention provides systems and methods for automating the conversion of digital images from a first storage media used by digital cameras to a second storage media used by computers and video playback devices. The conversion can be performed by a self-contained kiosk which detects the insertion of the first storage media containing the images in a first format. A processor at the kiosk converts the images into a second format (e.g., one that is compatible with video playback devices such as a DVD player). The images may then be copied to and stored on a second storage media in both the first (original) format and the second format. The second storage media is then dispensed from the kiosk. The resulting second storage media is compatible with video playback devices and serves as a master negative.

### BACKGROUND OF THE INVENTION

The present invention relates to digital photography. In particular, the present invention relates to a kiosk for processing consumer digital photos and storing them on media that can serve, for example, as a digital negative. In addition, the present invention provides methods and apparatus for automating the conversion of digital images from a first storage media used by digital cameras to a second storage media used by computers and video playback devices

Each year digital cameras gain an increasingly larger share of a market that was once dominated by cameras which relied on photographic film. Unlike film, a digital storage media is used in digital cameras. Therefore, once an image has been captured and saved, the quality is no longer prone to degradation over time and variations that are inherent in the film development and reproduction processes. Digital cameras are also capable of presenting an instant rendition of each captured image. Such instant renditions are extremely useful when deciding whether to attempt an additional image capture, usually with a camera setting or vantage point that seeks to compensate for a shortcoming that was observed in the first rendition. Conversely, when an image has been captured to film, it may be difficult to predict the success of the capture, and this often leads to unsatisfactory results or the additional expense of processing multiple snapshots of the same scene. Although today's digital cameras still carry a cost premium over comparable film-based cameras, many digital cameras are now capable of rendering images at a quality level that approaches the capabilities of 35 mm film.

Unfortunately, digital cameras also come with a few disadvantages. The flash media devices commonly used to record digital images are more expensive than the film cartridges that they replace. Fortunately, the flash devices are reusable, so if the data can be offloaded to alternative storage devices such as a user's PC, then this does not pose a problem. However, if the user of the digital camera is traveling abroad and does not have access to alternative storage devices, then the user must either purchase additional flash media, delete one or more previously captured images, or refrain from further use of the camera.

A second disadvantage of digital cameras is that the user must possess adequate computer skills or else give up many of the advantages and features that the digital camera was designed to offer. For example, images stored on digital media are designed to be compatible with common computer hardware and the software used to operate them. The images can be transferred to local or networked computer storage systems and subsequently manipulated, enhanced, printed in combination with custom graphic art, or simply displayed on local monitors or even a television set. Unfortunately, many consumers pay the premium to own a digital camera, and yet rely solely on processing labs to extract the recorded digital content and perform a conversion to photographic prints.

It would be advantageous to provide a simplified method of obtaining extracting digital images from a digital camera and storing then on an alternate storage media to enable reuse of the flash media of the digital camera. It would also be advantageous to provide a simplified method of converting the digital images from the format as stored on the digital camera's flash media into a second format suitable for viewing on video playback devices. It would also be advantageous to provide a simplified method of creating digital photo archives.

The methods and apparatus of the present invention provide the foregoing and other advantages.

### SUMMARY OF THE INVENTION

The present invention provides systems and methods for automating the conversion of digital images from a first storage media used by digital cameras to a second storage media used by computers and video playback devices. The conversion can be performed by a self-contained unit or kiosk device which detects the presence of the first storage media containing the images in a first format. A processor at the kiosk accesses the images from the first media and reads the image files from the first storage media. The processor may perform a conversion and resizing process that renders the images in a second format, for example, one that is compatible with video playback devices such as DVD (Digital Video Disk) player. The images may then be copied to and stored on a second storage media in both the first (original) format and the second format. The second storage media is then dispensed from the kiosk. The resulting second storage media is not only compatible with video playback devices, but also serves as the master negative.

When the process is completed and the second storage media is subsequently inserted into a video playback device, the converted and resized images in the second format will be detected, and can be displayed either automatically or by operation of the user controls provided with the video playback device. Similarly, if the second storage media is inserted into a compatible media drive of a computer or similar device, then the copies of the original images in the first format will be detected, and can be displayed or processed using the user controls of the computer or similar device. Alternatively, if the computer contains software that is compatible with the format of the video playback device, then the converted and resized images could be accessed instead. However, the copies of the original images in the first format should always be used when applications demand maximum image resolution and fidelity.

The second storage media can either be inserted into the kiosk media drive by the operator, or it may be inserted automatically if the kiosk is equipped with a robotic arm mechanism. Robotic mechanisms for selecting a single compact disk or DVD from a supplied stack of unrecorded disks, and inserting the selected disk into a media drive, are commonly available in compact disk or DVD duplication devices, and therefore will not be described in any further detail. Once inserted, the kiosk then records the images and all associated data onto this second storage media, and ejects the media from the media recorder device once the recording step has been completed. If suitably equipped, the kiosk will also print one or more pages of thumbnail images, and eject each printed page into a tray or other suitable receptacle.

Payment for the use of the kiosk device can be supplied in a number of ways. In the simplest case, the payment process would be independent and would affect neither the design nor the operation of the kiosk. For example, a customer could use the kiosk to generate a compact disk from the images captured by his camera onto compact flash, and then proceed to a cashier in order to provide payment. Alternatively, the kiosk could be provided with, for example, a credit card reading device and/or currency detection and reception devices in order to facilitate self-payments in unmanned locations.

One of the most important advantages of the kiosk device is that it permits images to be created and stored in a format that permits convenient viewing without the need for computers and the skill that is needed to operate them. Instead, the images can be displayed in a television-viewing environment, where the larger screen sizes and more abundant and comfortable seating arrangements are usually better suited for a viewing audience. The user simply inserts the storage media into the media drive of the video playback device, for example a DVD player, and scans through the recorded images using the player's remote control unit to advance either forward or backwards, or to access a menu which may be used to randomly access all available images.

In one example embodiment of the present invention, a method for processing digital photo images is provided. The insertion of a first media containing the photo images in a first format into a receptacle of a kiosk is detected. The images are accessed from the first media and converted into a second format adapted for display on a video appliance such as a television, DVD player, personal computer, or the like. The accessed images are stored in the first and second formats on a second media readable by the video appliance. The second media is dispensed to a user after the storing step.

The second storage media includes the original images in a first format, for example a digital image format, that is compatible with both personal computers and the computerized photo-processing systems that are used in photo labs for producing prints. The second format may be a video format, such as an MPEG format.

The first storage media may comprise any type of digital camera storage media, such as optical memory, flash memory, memory stick, magnetic memory, semiconductor memory, or the like. The second media may comprise a CD, a VCD, a DVD, or the like.

The accessed images may be converted into thumbnail images. The thumbnail images may be displayed on a display screen of the kiosk. The thumbnail images may be printed on a substrate (e.g., a page of photographic paper, a label, or the like) and/or stored on the second media. Each thumbnail is a replication of a corresponding image, but is small enough to allow a relatively large number of similar thumbnails, each with a different corresponding image, to be printed on a single page. If necessary, additional pages can be used to accommodate even more thumbnails.

The thumbnail prints can be used to facilitate convenient packaging and storage of a large number of the second storage media units. The thumbnail prints are particularly useful when browsing or when searching through a library of media units for a subset of one or more images.

A name can be associated with each image on the first media. The name can be selected from a predetermined set of names. The names from the first media can be associated to form an association of names. The association of names can be stored on the second media. For example, with use of a digital camera, the digital camera includes a factory programmed internally mapped file name. The file name is typically a peculiar number that the camera manufacturer uses to identify the file. It is desired to associate a user-friendly name with the manufacturer file name that can correlate with and preserve the original manufacturer file name. The name can be as simple as a sequential list of numbers (e.g., 1-200) that provide a means of identifying the images for the user in order to better utilize the images. Thus, for example, a camera image identifier of 001_{—}123.jpg can be associated with a user-friendly name such as “image 1.”

One advantage of the kiosk device is that it can be designed to operate without operator intervention. The operator simply removes the first storage media from the digital camera and inserts it into the kiosk. The kiosk can automatically detect the insertion of this first storage media and immediately begin generating the information needed to create the second storage media. Alternatively, a user may be given the option to designate certain parameters in order to regulate certain features or characteristics of the accessing, converting, and storing processes. This option can be set to expire after a predetermined time period using a time-out mechanism. For example, if a particular operator doesn't understand a particular setting, or doesn't wish to make any alterations, then the process can automatically proceed after waiting for a pre-determined interval without detecting any input from the operator. Pre-programmed default settings can be used instead.

At least one operational parameter may be stored on the second media. The operational parameter may control at least one of: (i) an output resolution; (ii) output aspect ratio; (iii) image display time; (iv) a software application associated with the video appliance, or the like.

User interface software may be stored on the second media for use when the second media is played by the video appliance or a personal computer.

After the second storage media is created, the kiosk may notify the user to retrieve the first media. Alternatively, the kiosk may automatically return the first media to the user.

The images may be deleted by the kiosk from the first media after the storing step.

A backup copy of the images may be stored in storage associated with the kiosk. The storage may be at least one of local storage internal to the kiosk or remote storage accessible to the kiosk via a network. The images may be initially stored in internal storage of the kiosk for subsequent transfer to the remote storage via the network.

Messages may be displayed on a display screen of the kiosk during processing of the images. The messages may comprise at least one of status information and configuration parameter options. The messages may also comprise one of advertisements, news bulletins, weather information, and the like.

As discussed above, the present invention also provides a kiosk for processing digital photo images in accordance with the above-mentioned methods. In one example embodiment, the kiosk includes a receptacle for receiving a first media containing the images in a first format. A processor at the kiosk detects the first media when inserted into the receptacle and accesses the images from the first media. After the images are accessed, the processor converts the images into a second format adapted for display on a video appliance. A media writer is provided for storing the accessed images in the first and second formats on a second media readable by the video appliance. The second media is then dispensed from the kiosk after the accessed images are stored thereon.

The processor may be adapted to provide at least one operational parameter for storage on the second media, as discussed above.

The media writer may be adapted to store user interface software on the second media for use when the second media is played by the video appliance or a personal computer.

The kiosk may also include a display. Thumbnail images of the accessed images may be displayed on the kiosk display. A printer may be provided for printing the thumbnails on a substrate.

Messages may be displayed on the display screen during processing of the images. The messages may comprise at least one of status information and configuration parameter options. The messages may also comprise one of advertisements, news bulletins, weather information, or the like.

A receptacle for receiving the second media from a user may be provided at the kiosk. Alternatively, a mechanism may be provided for automatically loading the second media from a supply thereof maintained in the kiosk.

The kiosk may include at least one of a credit card reader and cash acceptor. The media writer may be adapted to store accounting information on the second media.

The kiosk may include a plurality of receptacles for accepting first media having different formats. One of the receptacles may comprise a USB connector. A receptacle may be provided for receiving a connection from a digital camera having images to be uploaded to the kiosk.

A method for creating digital photo archives is also provided by the present invention. An example embodiment of such a method includes the following steps:

(1) detecting a digital image carrier;

(2) accessing contents of the carrier;

(3) detecting a digital photo archive storage media;

(4) processing the accessed contents to provide the contents in at least two formats for storage on the media, at least one of the formats being a digital photo archival format;

(5) storing the processed contents in both formats on the media; and

(6) dispensing the media containing the processed contents.

The digital image carrier may comprise a digital camera, the storage element of a digital camera, a digital mobile phone, a digital storage device, or similar device, each adapted to provide the contents thereof over an electronic link. The electronic link may be either a wired or wireless link. The electronic link may also be an optical link.

One of the formats may be a format in which the digital image is received from the digital image carrier, and one of the formats may be a television format. Alternatively, one of the formats may be a format in which the digital image is received from the digital image carrier, and one of the formats may be adapted for displaying digital images on a computer display.

The accessed contents may be processed to provide thumbnail images. The thumbnail images may be printed on a substrate and/or stored on the media. The substrate may comprise a surface of the media. All or only a portion of the thumbnail images may be printed on the surface of the media.

A capacity of the media may be determined prior to the storing step. If the capacity is not sufficient to store all of the processed contents, the processed contents may be divided for storage on a plurality of digital photo archive storage media. Alternatively, if the capacity is not sufficient to store all of the processed contents in a current form, the processed contents may be compressed for storage on the media.

### BRIEF DESCRIPTION OF THE DRAWINGS

The present invention will hereinafter be described in conjunction with the appended drawing figures, wherein like reference numerals denote like elements, and:

FIG. 1 shows an example embodiment of a kiosk in accordance with the invention;

FIG. 2 shows a block diagram of an example embodiment of the present invention;

FIG. 3 (FIGS. 3A and 3B) shows a flowchart illustrating an example embodiment of the present invention;

FIG. 4 shows a flowchart of an example embodiment of digital image processing in accordance with the present invention;

FIG. 5 shows an example embodiment of a labeled CD produced in accordance with the invention; and

FIG. 6 shows an example embodiment of a page containing thumbnail images produced in accordance with the invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

Compact disks are the most prevalent format in use today for the distribution of both computer software and digital audio. Compact disks can also be used to distribute video, however with a capacity of approximately 700 MB, they are only suitable for content having short duration, or for highly compressed content that can only be rendered with relatively poor image quality. VCD (Video Compact Disk) is an example of a highly compressed format used to distribute video and audio using the compact disk media.

DVD media is a format that is similar to compact disk in appearance, but supports much higher recording densities, and is therefore able to accommodate high quality renditions of programs exceeding 2 hours duration. As a result of the superior video quality permitted by the increased recording capacity, as well as the small size and convenient form factor, and the ability to randomly access different parts of a program, DVD media is beginning to surpass video cassette tapes, as the most popular means for distributing video.

In addition to DVD media, most DVD players will also accept the compact disk format, either to play audio, or to render video that has been recorded as VCD. The compression format used to create VCD video is referred to as the MPEG-1 standard. This compression standard can not only be applied to moving video, but to still images as well, and in the absence of motion, the MPEG-1 format is almost as effective as the MPEG-2 compression format that is used with DVD's. Also, when handling still images, the VCD standard supports a special mode where images can be displayed at the higher resolution that is used with DVD's. Most DVD players will also recognize the playback control formatting that identifies the images as single frames that should be displayed one at a time instead of in sequence at the normal display rate. In addition to being compatible with both computers and DVD players, and to being recordable in a format that permits single frame playback on common DVD players, compact disks are also much more economical than DVD's, particularly when it comes to the hardware needed for burning or recording new content. For these reasons, compact disks are currently the preferred choice for the output format (second storage media) of the kiosk device.

The preferred embodiment of the invention also assumes that the format of the first storage device is the compact flash memory commonly used in most digital cameras. Ultra compact flash, secure compact flash, and memory stick are just a few variations of media that falls within the compact flash classification.

Although the first and second media are respectively referred to as compact flash and compact disk (CD) in the following description of the preferred embodiment, the invention is not limited to these media formats. Those skilled in the art will appreciate that the first and second formats may take a variety of forms.

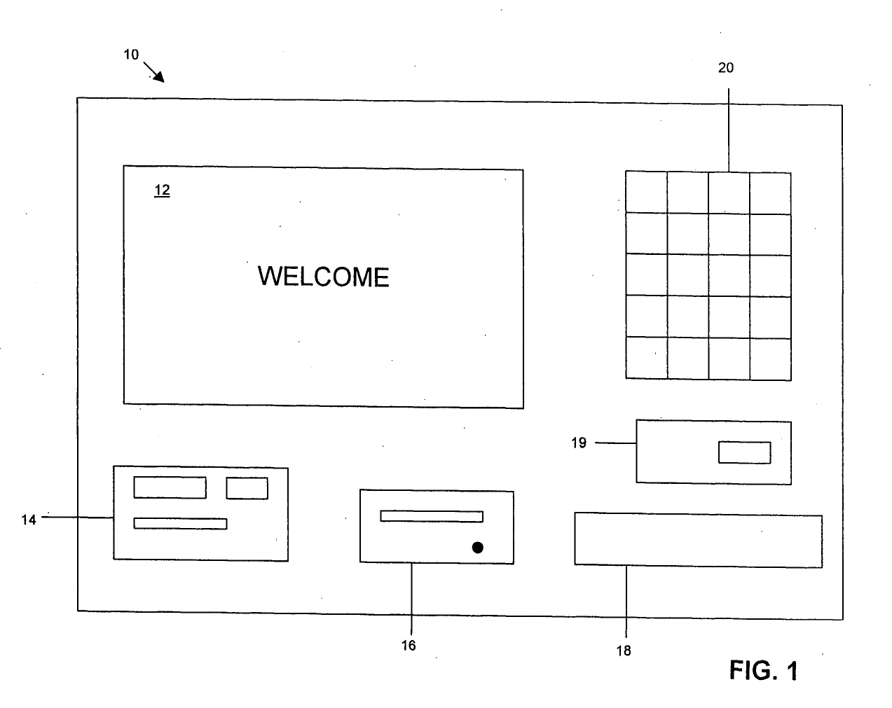

An example embodiment of a kiosk in accordance with the invention, capable of extracting digital images from compact flash, converting digital images from a first original format to a second format, and recording both the original images in the first format and the converted images in the second format onto compact disk, is shown in FIG. 1. The kiosk 10 includes a receptacle 14 for accepting the compact flash media from the digital camera. Since common compact flash may exist in a variety of physical formats, multiple receptacles 14 are provided. A display device 12 is provided, together with a keypad 20 for user input. The kiosk 10 includes a compact disk drive 16 which records the processed digital images onto compact disk media when inserted into the drive 16. An integrated printer 18 dispenses thumbnail prints of the images.

Payment for the use of the kiosk 10 can be supplied in a number of ways. In the simplest case, the payment process would be independent and would affect neither the design nor the operation of the kiosk 10. For example, a customer could use the kiosk 10 to generate a compact disk from the images captured by his camera onto compact flash, and then proceed to a cashier in order to provide payment. Alternatively, the kiosk 10 could be provided with a payment processing device 19. The payment processing device 19 may comprise, for example, a credit card reading device and/or currency detection and reception devices in order to facilitate self-payments in unmanned locations. Receipts may be printed and dispensed by the printing device 18. In some cases, it may be desirable to provide accurate and tamper-proof accounting for each kiosk transaction. This can be done by pre-recording information onto the second storage media or by maintaining and communicating certain information gathered by the kiosk.

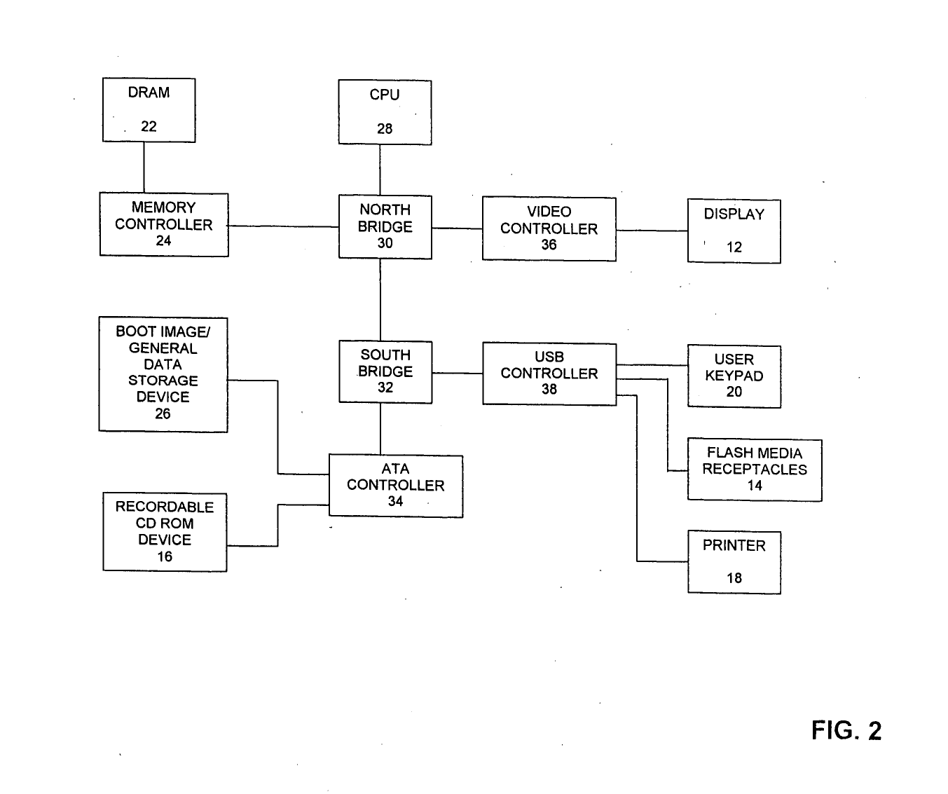

A simplified block diagram of the hardware components and interconnecting buses which comprise the kiosk unit 10 of FIG. 1 is shown in FIG. 2. Compact disk drives such as drive 16 are commonly equipped with an ATA interface (ATA controller 34), also known as IDE (Integrated Device Electronics). ATA interface cabling may include a 40 or 80 pin ribbon cable or a seven wire cable if using the more recent ATA serial interface. In this example embodiment, the ATA interface 34 is used to connect a boot device 26 which provides the software for the CPU 28. The boot device 26 may be a hard disk, a flash memory, or other non-volatile memory device.

Compact flash receptacle devices 14 are commonly available and are often provided with a USB (Universal Serial Bus) interface (USB controller 38) for attachment to other devices or controllers. In this example, the same USB interface 38 is used to connect a printer 18 for producing the thumbnail prints. Also included in the kiosk 10 is a display device 12 for providing information to the kiosk user. Examples of display devices are CRT's (Cathode Ray Tube) and LCD's (Liquid Crystal Display). Some LCD's are equipped with a touch screen interface, which can be used to accept input from the kiosk user. Alternatively, user input can be provided by a separate keypad device 20.

In the example embodiment shown in FIG. 2, two bridge devices are used to interconnect the various components. Components equipped with industry standard interfaces such as USB and ATA are connected to the South Bridge 32. The North Bridge 30 interconnects the South Bridge 32 with the higher performance buses that are needed for communication between the processor (CPU 28), Dynamic Random Access Memory (DRAM 22) and video controller 36 (e.g., an AGP (Accelerated Graphics Port) video controller). This architecture is similar to that which has been adopted by the personal computer industry.

The process of accepting the flash media and the recordable CD media, and interacting with the user to create the digital data to be burned onto the compact disk, is controlled by software running on a central processor (CPU 28). This software, along with the operating system and the drivers needed to access the component hardware, is extracted from the boot device 26 when the kiosk 10 is powered up.

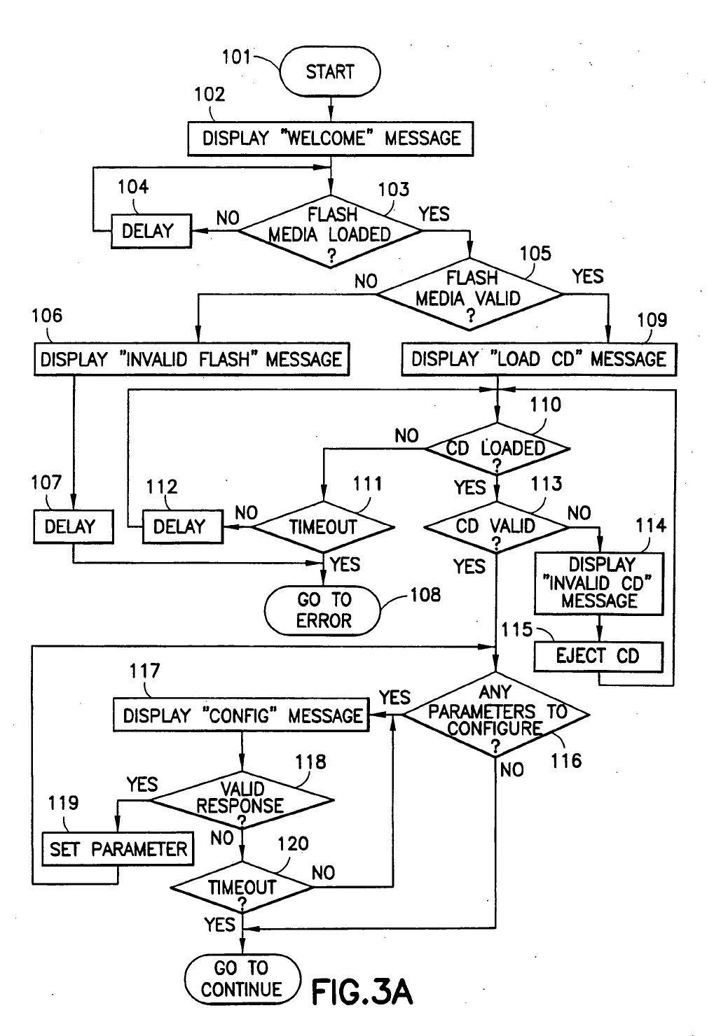

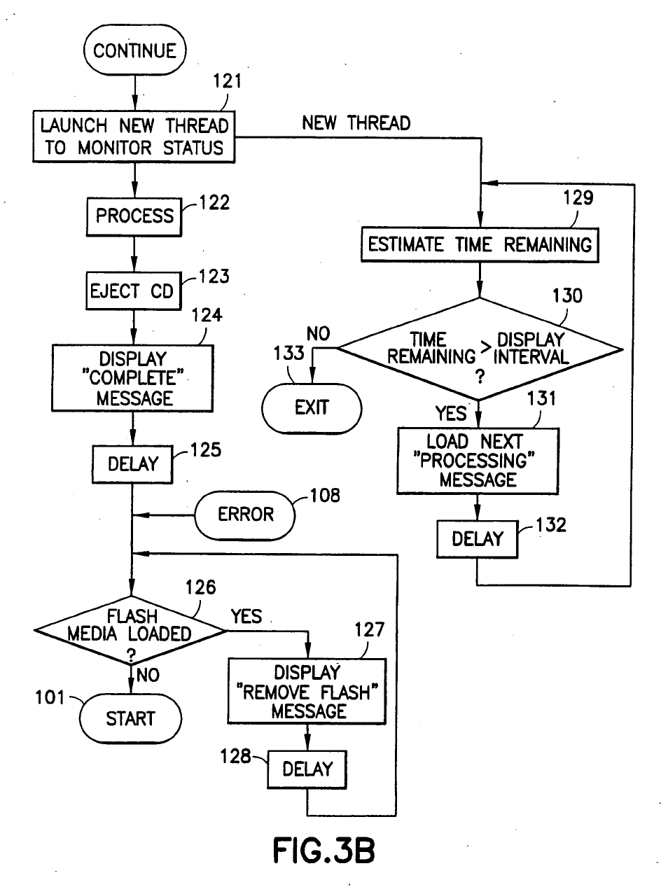

A flowchart which describes an example embodiment of the application process, beginning with the insertion of the compact flash device, and ending with the ejection of the completed compact disk and thumbnail prints, is shown in FIG. 3. After startup (step 101) the kiosk display will display a “Welcome” message (step 102). The kiosk will detect whether the first media (e.g., flash media) containing the images from the digital camera is inserted at the kiosk (step 103). If the flash media is not yet loaded, a delay (step 104) is activated in order to wait for the insertion of the media. Once the kiosk verifies that the media is loaded, it will determine whether the media is valid (step 105). If the media is invalid, the kiosk display will display a “Invalid flash” message (step 106) and then a delay will be activated (step 107). After a delay, an error (step 108) will be acknowledged and the kiosk will check to determine whether the flash media remains loaded in the receptacle (step 126). If the media has been removed, the kiosk will revert back to start (step 101). If the media is still loaded, the kiosk display will display a “Remove flash media” message (step 127).

If the media is valid, the kiosk display will display a “Load CD” message (step 109). The kiosk will check to verify that the CD is loaded (step 110). If no CD is loaded, the kiosk will check to determine whether a predetermined time (e.g., a timeout) has passed since the “Load CD” message was displayed (step 111). If the timeout has not lapsed, a delay will be activated (step 112) and the kiosk will recheck to determine whether the CD is loaded after the delay (step 110). If the timeout has lapsed, an error will be acknowledged (step 108). The kiosk will then check to determine whether the flash media remains loaded in the receptacle (step 126). If the media has been removed, the kiosk will revert back to start (step 101). If the media is still loaded, the kiosk display will display a “Remove flash media” message (step 127).

Once it is verified that the CD is loaded, it is determined whether the CD is valid (step 113). If the CD is invalid, the kiosk display will display a “CD invalid” message (step 114) and then eject the CD (step 115) before rechecking whether the CD is loaded (step 110). If the CD is valid, the kiosk will determine whether there are any parameters to configure (step 116). If there are parameters to configure, the kiosk display will display a “Configuration” message (or a series of configuration messages) (step 117), requesting the user to input configuration parameters. The kiosk will determine whether a valid response to the configuration message has been entered (step 118). If so, the kiosk will set the parameter (step 119) and determine whether any additional parameters need to be configured (step 115). If no valid response is received to the configuration message, a timeout is implemented (step 120). Once the timeout lapses and no response is received, a new processing thread is launched to monitor the status of the image processing (step 121). If there are no parameters to consider or all parameters have been entered (step 116) then the new processing thread is launched (step 121) and the processing continues with default parameters or the entered parameters (or a combination thereof).

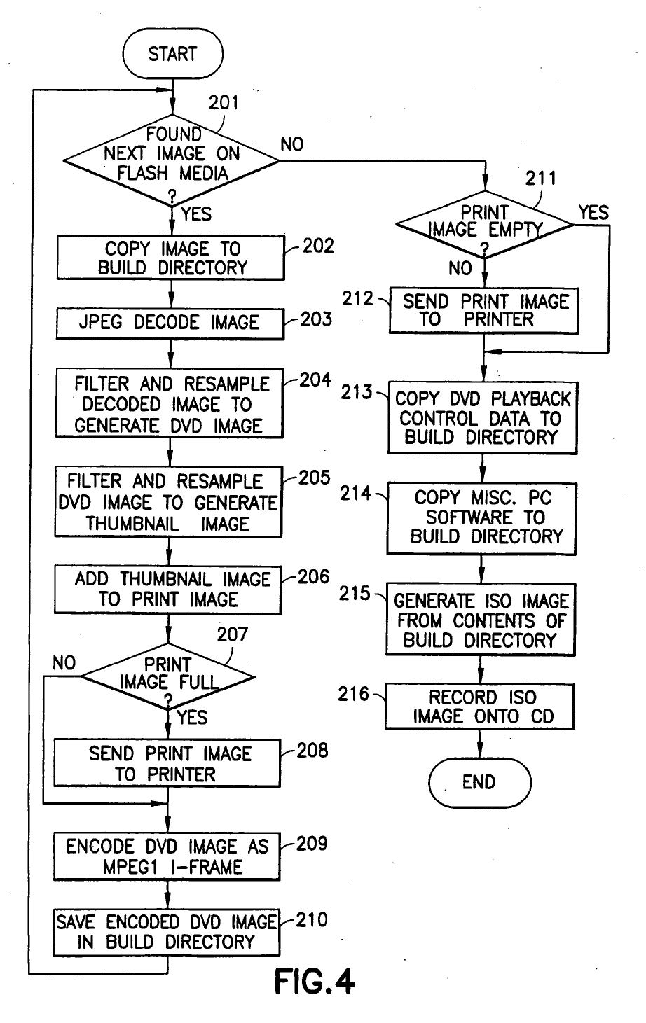

Once the configuration parameters are established, the images are then processed to convert them from the first format into the second format and to store both the original images in the first format and the converted images in the second format on a second media (step 122). The process step 122 in FIG. 3 is described in more detail below in connection with FIG. 4.

Once the image processing is complete, the CD is ejected (step 123). The kiosk display then displays a “Processing complete” message (step 124). A delay is implemented (step 125). After the delay, provided to enable the user to remove the flash media, the kiosk will determine whether the flash media remains loaded (step 126). If no flash media is detected, the kiosk reverts to the start of the process (step 101) and awaits the next customer. If a flash media is detected, the kiosk display will display a “Remove Flash media” message (step 127). A delay will then be activated (step 128) and the kiosk will again recheck to see if the flash media is loaded (step 126).

The new processing thread launched by the kiosk (step 121) serves to monitor the status of the image processing and occurs parallel to the processing steps 122-125. The new processing thread estimates the processing time remaining (step 129). A timing circuit will determine whether a display interval for the display of a processing message is greater than the estimated time remaining (step 130). If the estimated time remaining (computed at step 129) is greater than the display interval, a “processing message” will be displayed (step 131). After a delay (step 132), the estimated time remaining will be recomputed (step 129) and rechecked against the display interval (step 130) to determine if the next processing image can be displayed (step 131). If the time remaining is less than the display interval, the second thread is exited (step 133). The processing messages may include information about the status of the processing. Alternatively, the processing messages may include advertisements, news bulletins, weather information, or the like. However, this may require either a link to an external information site, or regular updates to the system software.

As discussed above, during the processing of the images, various messages may be presented on the display device 12 in order to gather optional information for regulating the conversion, recording, and printing processes, and to provide status information to the user. Examples of presented messages corresponding to the process outlined in FIG. 3, are shown below in Table 1.

TABLE 1
On-Screen Messages

| SCREEN TITLE | DISPLAYED MESSAGE |
|---|---|
| Welcome | Welcome |
| | Please load flash media |
| Load CD | Please load CD media |
| Invalid flash | Flash media not valid |
| Invalid CD | CD media not valid |
| Configuration Options | Choose configuration |
| | parameter options: |
| | Default? |
| | Media parameters: |
| | Number of CD copies? |
| | Include all images or select subset? |
| | Erase flash media when done? |
| | DVD display parameters: |
| | select low resolution? |
| | (choose this option if your |
| | DVD player does not |
| | support high resolution) |
| | select wide screen format? |
| | specify display duration? |
| | (defaults to infinite duration) |
| Preprocessing | Preparing to create CD |
| | Please wait |
| Processing Start | Time remaining 0:00 |
| Processing message 1 | Advertisement 1 |
| | Time remaining 0:00 |
| Processing message 2 | Advertisement 2 |
| | Time remaining 0:00 |

•
•
•

| | |
|---|---|
| Processing message n | Advertisement n |
| | Time remaining 0:00 |
| Processing complete | Processing complete |
| | Please remove flash media, CD |
| | media, and printed jacket |

In this example embodiment, the user is provided an opportunity to alter certain configuration parameters. The parameters listed in Table 1 are exemplary only. Those skilled in the art will appreciate that a wide variety of parameter options may be provided.

Media specific parameters include the number of CD copies, and the images to include or exclude from the transfer process. To help with the image selection decision, all available images could be presented on the display 12 in thumbnail format. In this case, a touch-screen display would be particularly convenient. The user could simply specify an include or exclude mode, and then touch the thumbnails corresponding to the images that are to be included or excluded, respectively.

The user could also specify whether the images on his compact flash should be deleted upon completion of the transfer process. If deleted, the compact flash would be ready for immediate reuse when reinserted into the digital camera.

Additional parameters can affect behavior when the completed compact disk is inserted into a DVD player or a personal computer. For instance, data that is recorded onto the CD can control whether the DVD player will display images in high resolution (480/576 lines by 720 pixels/line) or low resolution (240/288 lines by 360 pixels/line), the aspect ratio (16:9 or 4:3), and the time that each image is displayed on the television screen before automatically advancing to the next image. Additional parameters can specify which software applications are loaded onto the CD in order to provide additional functionality when the CD is inserted into the media drive of a personal computer. Any remaining space on the CD can be used to accommodate a variety of applications that may be recognized by one or more computer platforms and operating systems. Examples are applications which can display, edit or print the accompanying images, or provide networked access to businesses offering professional image processing services.

The process step 122 in the flowchart of FIG. 3 is shown in more detail in FIG. 4. Each successive image is read from the compact flash (step 201), and copied to a directory where all recordable data is collected (step 202). A first copy remains unchanged from the representation on the compact flash. However, in order to be recognized by common DVD players, a conversion process is applied to create a second copy. Digital cameras typically compress each image using the JPEG compression standard, whereas DVD players will only recognize images on compact disk if they are compressed using the MPEG-1 standard. There is considerable similarity between JPEG and the subset of MPEG-1 that is applicable to still images. However, since the resolution of the images must be reduced in order to become compatible with DVD players and televisions sets, there are few shortcuts that can be applied when converting between the two standards. Therefore the preferred conversion procedure is to first decode the JPEG image in order to recover an approximation of the original pixels (step 203). The dimensions of this uncompressed image can then be reduced using conventional filtering and decimation techniques (step 204). Although the original image resolution can vary depending on the particular camera and the settings that were in use at the time that the picture was taken, the dimensions necessary for DVD compatibility are limited. Most DVD players will support high resolution mode. For NTSC systems, high resolution implies 480 pixels in the vertical dimension and 720 pixels in the horizontal dimension. For PAL systems, high resolution implies 576 lines pixels vertically and 720 pixels horizontally. If using low resolution mode, then both dimensions are halved. Many DVD players will accept both PAL and NTSC resolutions, and output the proper format to the television set.

Thumbnail images can also be created as each image is processed. Thumbnails are small images with very low resolution which can be created by further decimation of the uncompressed image (step 205). Filtering is again required in order to prevent aliasing which can cause the thumbnails to become unrecognizable. However, since the thumbnail dimensions are very small, there is little computational burden to using a good filter with a large number of taps. Once the thumbnail is generated, it can be included on a page used to collect the thumbnails corresponding to each successive image (step 206). If it is determined that the page becomes full (step 207), and cannot accommodate an additional thumbnail, then it is immediately queued for printing (step 208). A new page can then be prepared to collect the thumbnails corresponding to any remaining images that have not yet been processed.

Once the image has been decoded and adjusted to DVD-compatible dimensions, it can then be encoded as an MPEG-1 still image (step 209). More specifically, it is encoded as an MPEG-1 I-frame. I-frames differ from P-frames and B-frames, since the encoding and decoding processes can be performed without accessing any information that may be contained in other images. In contrast, more typical MPEG-1 applications involve motion video where a stream of images occur in sequence, and depending on the speed and complexity of movements, there may be considerable similarity among images that are closely separated in time. In such cases, most images are designated as B-frames and P-frames and only the information that cannot be predicted from one or more neighboring frames is encoded. By taking advantage of the inter-frame correlation, P frames, and particularly B-frames, can be encoded much more efficiently than I-frames. I-frames are only inserted periodically so that the sequence may be acquired by a decoder that just tunes in to the compressed data stream and does not have access to any preceding frames, or to ensure that the decoder is able to recover synchronization which may be lost in the event of transmission channel errors, and to limit the accumulation of errors attributable to losses in arithmetic precision. However, in the photo kiosk application, the P-frame and B-frame encoding modes are not used since it is desirable to maintain complete independence from one image to the next, and there is usually very little inter-frame correlation that could be utilized to improve compression efficiency. Note that a kiosk designed to accept DVD media instead of compact disks, would compress the images as MPEG-2 I-frames instead of MPEG-1 I-frames. The classification of images into I-frames, P-frames, and B-frames is common to both compression standards.

Once the image has been encoded as an MPEG-1 I-frame, it is copied to the same location as the original JPEG copy (step 210). This process is repeated until all images have been processed, at which time the directory will include a full-quality JPEG representation and a DVD-compatible MPEG-1 representation corresponding to each image. Once it is determined that there are no more images to be processed on the flash media (step 201), it is determined whether the print image page is empty (step 211). If the page is not empty, it is sent to the printer for printing (step 212). If the page is empty, or once the page is sent to the printer, the next step is to include software that may be useful for accessing the images on a personal computer and playback control data that will determine the image presentation order and display intervals when accessed with a DVD player (steps 213 and 214). It is also possible to create one or more menu screens that will be displayed when the CD is first inserted into the player. Each menu could be comprised of multiple thumbnail representations, each corresponding to a different image on the CD. If a particular thumbnail is selected using the controls of the DVD player, then the presentation could begin at the sequence location corresponding to the chosen image.

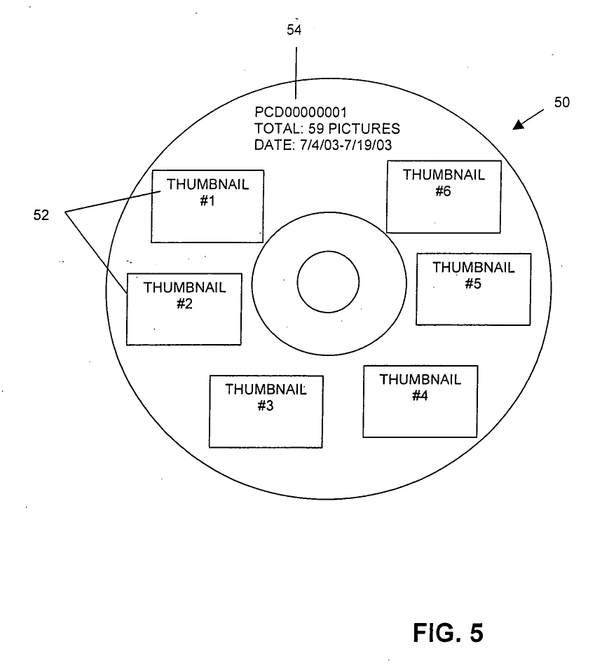

Before the data is recorded onto the CD, a unique album ID can be supplied to permit software identification and to facilitate future services that might be useful once the CD has been created. The same album ID can also be affixed to the CD media, either by direct printing onto the CD surface, or by printing out a label that can be attached to the CD surface. In an example embodiment, each kiosk 10 is provided with a unique ID. The CD's ID may be a combination of the machine ID with an internal counter in the machine. For example: machine PCD will make CD's with ID such as PCD00000001, PCD00000002, and PCD00000003. An example of a labeled CD is provided in FIG. 5. The labeled CD 50 includes several thumbnail images 52 as well as identifying data 54. The identifying data 54 includes the unique ID (in this case, PCD00000001), as well as the number of images on the CD and the date of the images.

Referring back to FIG. 4, the contents of the entire directory, including JPEG and MPEG-1 image representations, PC software, DVD playback control data, and album ID, may then be organized as an ISO 9660 file system (step 215) and recorded onto the CD (step 216). This widely-used format is recognized by almost all computer platforms. To minimize delay, ISO 9660 formatting can occur simultaneously with the CD-burning process.

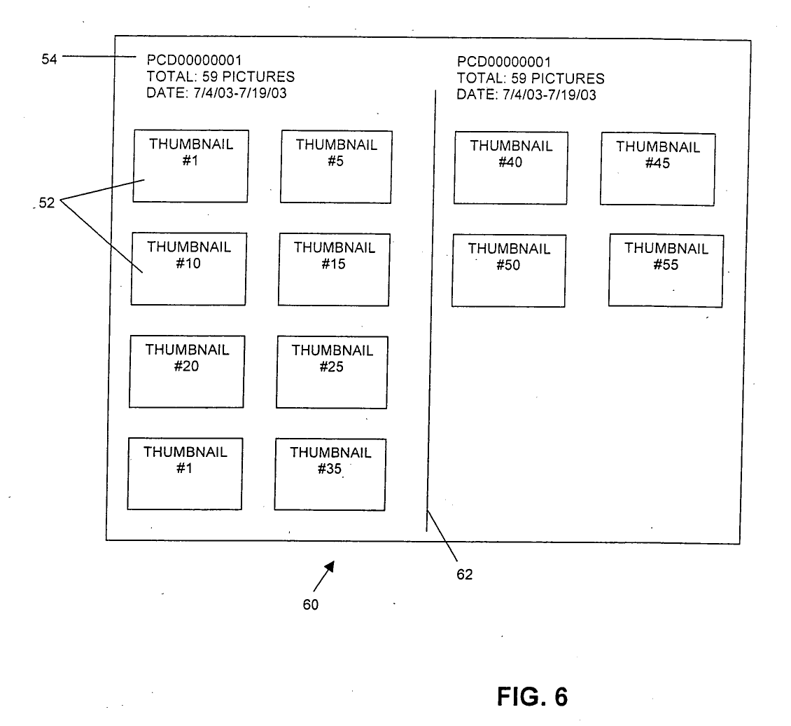

Once the CD has been recorded, it is ejected from the CD drive, and the user is instructed to remove both the CD and the compact flash from the kiosk 10. The thumbnail prints can be used to facilitate convenient packaging for the CD media. For example, as shown in FIG. 6, the thumbnails 52 could be arranged on the printed page 60. If it is desirable to limit all thumbnails to a single page, then a representative sample could be created by only selecting every nth thumbnail. Note that n is 5 in the example of FIG. 6. The page may also include identifying data 54, which may include, for example, the ID of the CD, the number of images on the CD, and the date of the images. The printed page 60 may then be folded in half along the indicated fold line 62 such that the printed thumbnails 52 remain on the outside surfaces of the folded page 60. The page 60 may then be inserted into a clear plastic sleeve commonly used to store CDs. Such a sleeve may include a flap along the top edge which opens to allow the folded page to be inserted. The result is a protected folder that can be used to contain the CD media. The CD can be inserted into the jacket by unfolding the same flap, and then placing the CD between the two surfaces created by the folded page. Holes may be precut along one edge of the plastic sleeve. These holes allow the sleeve containing the enclosed CD and its printed jacket to be safely stored in any ring binder that is compatible with the spacing of the holes. The binder can be used to maintain an entire library of CD media, while facilitating convenient browsing and access to the individual disks.

It should now be appreciated that the present invention provides advantageous methods and apparatus for converting digital images from a first format to a second format compatible with video playback devices and personal computers and storing the images in both the first and second formats on a second media, such as a CD or DVD.

Although the invention has been described in connection with various illustrated embodiments, numerous modifications and adaptations may be made thereto without departing from the spirit and scope of the invention as set forth in the claims.

What is claimed is:

1. A method for processing digital photo images comprising:
detecting the presence of a first media in a receptacle of a kiosk, said first media containing said images in a first format;
accessing said images from said first media in said first format;
converting the accessed images into a second format adapted for display on a video appliance;
storing said accessed images in at least one of said first format and second format on a second media readable by said video appliance; and
dispensing said second media to a user after said storing step.

2. The method in accordance with claim 1, wherein said first format is a digital image data format and said second format is a video format.

3. The method in accordance with claim 2, wherein said first media comprises a digital camera storage media.

4. The method in accordance with claim 3, wherein said second media comprises one of a CD, VCD, and DVD.

5. The method in accordance with claim 1, wherein said first format is adapted for use by at least one of a personal computer and a photo processing system.

6. The method in accordance with claim 1, wherein said video appliance comprises at least one of a computer, a VCD player and a DVD player.

7. The method in accordance with claim 1, wherein said first media device is at least one of a digital camera, a digital camcorder, a compact flash and a memory stick.

8. The method in accordance with claim 1, wherein said receptacle is at least one of a USB port, a digital camera interface, a digital media reader and an assembly of interfaces and digital media readers.

9. The method in accordance with claim 1 comprising:
creating a unique ID for said second media.

10. The method in accordance with claim 9 comprising at least one of:
printing said unique ID on a substrate;
printing said unique ID on a surface of said second media; and
storing said unique ID on said second media.

11. The method in accordance with claim 1, comprising:
associating the name of each image on said first media with at least one name from a predetermined set of names to form an association of names; and
storing said association of names on said second media.

12. The method in accordance with claim 1, comprising:
converting the accessed images into thumbnail images.

13. The method in accordance with claim 12, comprising:
printing said thumbnail images on a substrate;
printing an original name of each image with said thumbnail image;
printing an associated predetermined name with said thumbnail image;
printing one of (i) all of the thumbnail images and (ii) a subset of the thumbnail images on a surface of said second media; and
storing said thumbnail images on said second media.

14. The method in accordance with claim 1, comprising
detecting the presence, validity and capacity of said second media for storing all of the contents from said first media.

15. The method in accordance with claim 14, comprising:
storing a part of said all of the contents from said first media on said second media responsive to a total size of all the contents from said first media exceeding a capacity of said second media.

16. The method in accordance with claim 14, comprising:
storing and grouping said all of the contents from said first media onto multiple second media responsive to a total size of all the contents from said first media exceeding a capacity of said second media.

17. The method in accordance with claim 16, wherein said second media are moved to and from a media write device by robotic arm, in the absence of user intervention.

18. The method in accordance with claim 1, wherein said accessing, converting and storing steps are performable in the absence of user intervention.

19. The method in accordance with claim 18, wherein a user is given an option of designating parameters for at least one of said accessing, converting and storing steps.

20. The method in accordance with claim 19, wherein said option expires after a predetermined time period.

21. The method in accordance with claim 1, wherein said second format is an MPEG format.

22. The method in accordance with claim 1, comprising:
storing at least one operational parameter on said second media.

23. The method in accordance with claim 22, wherein said at least one operational parameter controls at least one of an output resolution, an output aspect ratio, an image display time and a software application associated with said video appliance.

24. The method in accordance with claim 1, comprising:
storing user interface software on said second media for use when said second media is played by one of said video appliance and a personal computer.

25. The method in accordance with claim 1, comprising:
notifying said user to retrieve said first media; and
automatically returning said first media to said user.

26. The method in accordance with claim 1, comprising:
deleting said images from said first media after said storing step.

27. The method in accordance with claim 1, comprising:
storing a backup of said images in storage associated with said kiosk.

28. The method in accordance with claim 27, wherein said storing is at least one of local storage internal to said kiosk and remote storage accessible to said kiosk via a network.

29. The method in accordance with claim 28, wherein said images are initially stored in internal storage of said kiosk for subsequent transfer to said remote storage via said network.

30. A kiosk for processing digital photo images comprising:
a receptacle for receiving a first media containing said images in a first format;
a processor for:
detecting said first media when inserted into said receptacle,
accessing said images from said first media, and
converting the accessed images into a second format adapted for display on a video appliance; and
a media writer for storing said accessed images in said first and second formats on a second media readable by said video appliance, wherein said second media is dispensed from the kiosk responsive to the accessed images being stored thereon.

31. The kiosk in accordance with claim 30, wherein said first format is a digital image data format and said second format is a video format.

32. The kiosk in accordance with claim 31, wherein said first media comprises a digital camera storage media.

33. The kiosk in accordance with claim 32, wherein said second media comprises one of a CD, a VCD, and a DVD.

34. The kiosk in accordance with 30 wherein said first format is adapted for use by at least one of a personal computer and a photo processing system.

35. The kiosk in accordance with claim 30 wherein said processor is adapted to convert the accessed images into thumbnail images.

36. The kiosk in accordance with claim 35, wherein said thumbnail images are stored on said second media.

37. The kiosk in accordance with claim 30 wherein said second format is an MPEG format.

38. The kiosk in accordance with claim 30 wherein said processor is adapted to provide at least one operational parameter for storage on said second media.

39. The kiosk in accordance with claim 38, wherein said operational parameter controls at least one of:
an output resolution;
output aspect ratio;
image display time;
a software application associated with said video appliance.

40. The kiosk in accordance with claim 30 wherein said media writer is adapted to store user interface software on said second media for use when the second media is played by said video appliance.

41. The kiosk in accordance with claim 30, wherein said kiosk further includes a printer for printing thumbnails of said accessed images on a substrate.

42. The kiosk in accordance with claim 30, comprising one of:
a receptacle for receiving said second media from a user; and
a mechanism for automatically loading said second media from a supply thereof maintained in the kiosk.

43. The kiosk in accordance with claim 30, wherein said first media is one of an optical memory, magnetic memory, flash memory, and semiconductor memory.

44. The kiosk in accordance with claim 30, wherein said kiosk includes at least one of a credit card reader and cash acceptor.

45. The kiosk in accordance with claim 44, wherein said media writer is adapted to store accounting information on said second media.

46. The kiosk in accordance with claim 30, comprising a plurality of receptacles for accepting first media having different formats.

47. The kiosk in accordance with claim 46, wherein one of said receptacles comprises a USB connector.

48. The kiosk in accordance with claim 30, comprising a receptacle for receiving a connection from a digital camera having images to be uploaded to the kiosk.
